(19) United States
(12) Patent Application Publication
(10) Pub. No.: US 2006/0226064 A1
(43) Pub. Date: Oct. 12, 2006

(54) Multiple cartridge carafe filtration

(76) Inventors: Robert Charles Beckman, Vail, NC (US); Robert W. Lackey, Hickory, NC (US)

Correspondence Address: John B. Hardaway, III;NEXSEN PRUET, LLC, P.O. Box 10107, Fed. Sta., Greenville, SC, 29603-0107, US

(21) Appl. No.: 11/387,116

(22) Filed: Mar. 22, 2006

Related U.S. Application Data
(60) Provisional application No. 60/664,544, filed on Mar. 23, 2005.

(51) Int. Cl. B01D 24/00

(52) U.S. Cl. 210/323.1; 210/466; 210/467; 210/470; 210/474; 210/266

(57) ABSTRACT

The invention is an improved carafe or water pitcher for the treatment of drinking and cooking water which uses multiple filters to treat the water to remove heavy metals, organics (especially VOC's), taste and odor.

### FIELD OF THE INVENTION

This invention relates to water filtration devices for drinking and cooking water and especially to pitchers and carafes containing improved filtration systems for treatment of potable water to remove taste, odor and trace contaminants.

### BACKGROUND AND PRIOR ART

Water sources for drinking water are typically reservoirs fed by rivers and wells. The water is inevitably contaminated by natural and man-made chemicals which are removed in large part at public or private water treatment facilities. Carafe or Pitcher Filter systems recently have supplanted all other point-of-use filters for the consumer market, both in numbers and sheer dollar value. The popularity of these carafe or pitcher systems derives from the convenience and ease of treatment by the consumers, typically in the kitchen environment, of water for drinking or for cooking purposes obtained from a water treatment facility or well. Modern advances in hygiene in the developed world owe much to the chlorination of drinking water. Chlorination of drinking water, developed by Abel Wolman in the early 1920's, is credited with dramatically reducing the morbidity and mortality caused by microbiological diseases in the population by reducing or eliminating the presence of microbiological contamination in the water. To keep pace with this increasing contamination of the sources of drinking water, Municipalities and Water Authorities have resorted to increased levels of chlorination. As a result the water increasingly smells and tastes of chlorine. The success of the carafe filter in recent times owes much to its ability to reduce taste and odor of chlorine in water at the point of its end use, usually the kitchen. This improvement in taste is very noticeable to consumers for drinking water and for water used for cooking. Besides the microbiological contamination of the source water, the same urban growth has also caused contamination with heavy metals, solvents, pharmaceuticals and pesticides. The Carafe or the Pitcher filter devices are able to treat these non-chlorine related contamination to some extent, but there are some problems in this area caused by the limitations of these carafe systems.

Numerous patents related to treatment of drinking water in carafes and pitchers may be found in International Classification BO1D or US Class 210.

### BRIEF DESCRIPTION OF THE INVENTION

It is the object of the invention to provide a novel, high capacity filtration system for a carafe or pitcher for drinking water purification. It is a second object of the invention to provide convenience and capability to treat a more expanded list of contaminants from the water. It is the third objective of this invention to provide a method for the prevention of bacterial growth on the surfaces of the carafe or within the filter cartridges contained in it.

These and other objects of the invention are attained by using multiple filter cartridges having fine granular media such as activated carbon, alumina, titania, iron oxide and cation exchange resins and by treating the plastic surfaces with antimicrobial additives and suspending pellets containing antimicrobial additives in contact with the granular media. The lifetime of the cartridges is determined by an electronic counter on the carafe, which gives a visual indication of the amount of water, which has been treated and the remaining capacity of the filters.

### BRIEF DESCRIPTION OF THE DRAWINGS

FIG. 1 is a plan view of a prior art pitcher having a single filter and a calendar indicator for determination of filter lifetime.

FIG. 2 is an elevation of a prior art pitcher having a single filter.

FIG. 3 is an oblique view of a prior art pitcher having a single filter.

FIG. 4 is a view at 90° to that of FIG. 2 of the prior art pitcher having a single filter.

FIG. 5 is a plan view of a pitcher according to this invention having a pair of filter cartridges and a capacity counter.

FIG. 6 is an elevation of a pitcher according to this invention having a pair of filter cartridges.

FIG. 7 is an oblique view of a pitcher according to this invention having a pair of filter cartridges.

FIG. 8 is a view at 90° to that of FIG. 6 of the pitcher according to this invention having a pair of filter cartridges.

### DETAILED DESCRIPTION OF THE INVENTION

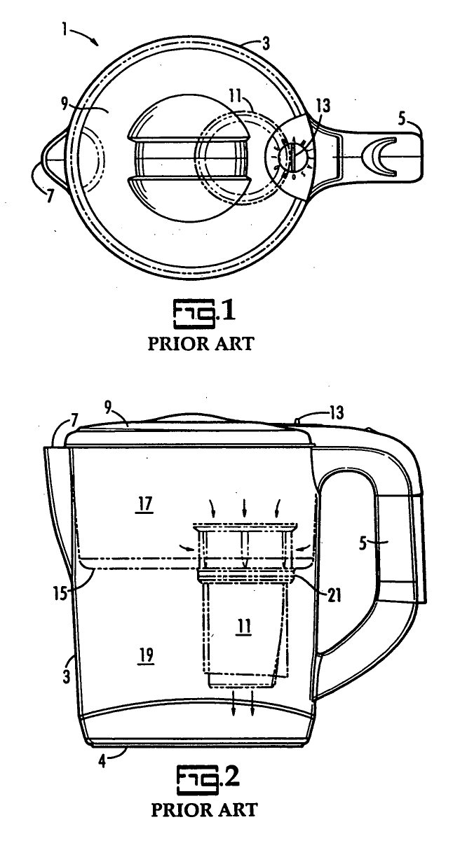

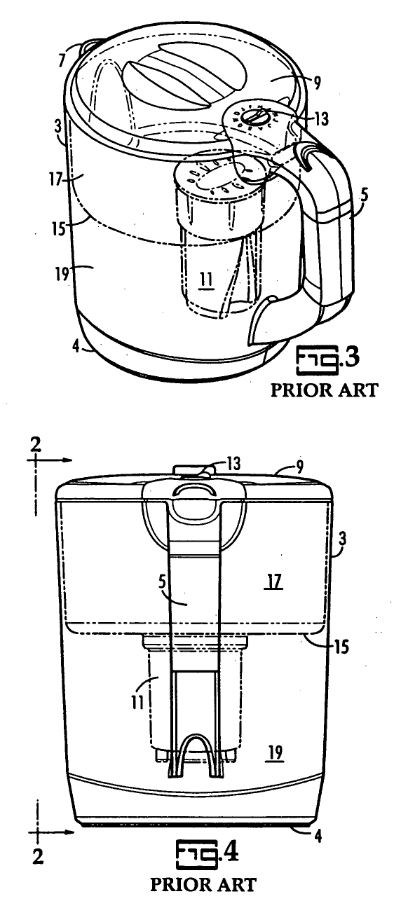

The conventional prior art pitcher for a water purification system is shown in FIGS. 1-4. The pitcher 1 has a generally cylindrical plan area defined by a wall 3 and a bottom 4. A handle 5 projects from one side and a spout 7 from the opposite side. A removable lid 9 protects the contents. Water is added to an upper chamber 17 separated from a lower chamber 19 by a floor 15. Water passes from the upper chamber to the lower chamber through a filter cartridge 11 which has a gasket 21 to prevent leakage. Filtered water is poured through spout 7 which is in communication with lower chamber 19.

Element 13 represents an indicator for exhaustion of the filter. Third party independent organizations such as NSF International (NSF), Underwriters Laboratories (UL), or Water Quality Association (WQA) certify various water filtration devices for their volume capacity to remove contaminants from the volume of water treated before a subject contaminant achieves breakthrough. Element 13 shows a monthly elapsed time indicator. These indicators can be either mechanical or electronic in design. There are ANSI/NSF Standards for certification of water treatment devices that specify the methodology for determining the breakthrough for each contaminant. The manufacturers of these devices obtain certification from these Independent Laboratories for breakthrough volume for the contaminants under various ANSI/NSF Standards.

Typically, the reservoir for the untreated water contains 1-2 liters of water and for the practical reasons this quantity of water must be filtered or treated by the intervening filter cartridge under gravity at the rate of 150 to 450/cc/min. Flow rates slower than 150 cc/min would be considered inconvenient by the user, and while flow rates faster than 350 will be appreciated by the user, one is confronted by the limitation of the granular material in the filter cartridge to treat the water fast enough. The filter cartridge contains granular material designed to remove specific impurities or contaminants from the water.

Depending on the nature of contaminant, appropriate material having chemical and/or physical affinity for that contaminant is used. One of the most common granular media used to remove chlorine, taste and odor form the water is the granular activated charcoal (carbon). It is also used to remove dissolved organic impurities such as insecticides, herbicides and organic solvents of various kinds that find their way into the sources of drinking water. Dissolved heavy metals such as lead, mercury, copper, zinc, arsenic etc. are also increasingly found in the sources of drinking water that are highly toxic to human beings. The granular media used to treat these dissolved heavy metals usually are various kinds of synthetic and proprietary ion exchange resins. Besides these two types, there are other contaminants such as nitrates, perchlorates, and various kinds of pharmaceuticals that require special kinds of granular media such as green sand, alumina, silica, titania, iron oxide, specialized synthetic ion exchange resins and other proprietary media.

In a typical application involving granular media, water containing the impurity is contacted with the media to adsorb the impurity onto the media and thus purity the said water. The effectiveness of this operation depends on the adsorption capacity of the media for the particular impurity and the contact time during which the media has the chance to remove the impurity from the water. Even with the optimum adsorption capability of the media for the impurity, if the contact time with the media is insufficient, the impurity from the water will not be fully removed.

In filtration technology, the Empty-Bed-Contact-Time (EBCT) expresses these kinds of solid/liquid contact considerations quantitatively. EBCT is a ratio of the volume of filter cartridge containing the granular media and the flow rate of water through it. (e.g.-volume in cc of filter cartridge filled with media divided by cc/min flow rate). The resultant ratio gives time in minutes that the untreated water is in contact with the media. Whether the treatment device is pressurized or not, it makes a big difference in the EBCT, as the former usually have higher flow rate resulting in the EBCT that is much smaller. THE EBCT for the pressurized systems are usually in the neighborhood of 1-10 sec, whereas the gravity flow systems such as the carafe or pitcher filters have EBCT that is one or two orders of magnitude higher—10-100 sec. For comparison, the EBCT for large industrial or municipal applications using granular media in large columns or vessels is 5-15 minutes. Here the vessels or columns containing the media can be made as large (usually arranged in series) to achieve the flow rate of 20 to 50 gallons per minute (gpm) with adequate EBCT to effectively remove the contaminant. The flow rates of pressurized Point-of-Use filter devices are usually in the range of 0.5 to 2 gpm, while those of the pitcher filters re 0.04 to 0.12 gpm (150-450 cc/min).

Different contaminants require different contact times with the media, as some adsorption reactions are mainly on the surface, such as in case of chlorine removal while others such as ion exchange for soluble metal removal are controlled by diffusion within the meso and micropores of the media. Thus EBCT for effective removal of various contaminants vary drastically and at a given EBCT not all contaminates are removed with the same degree of efficiency.

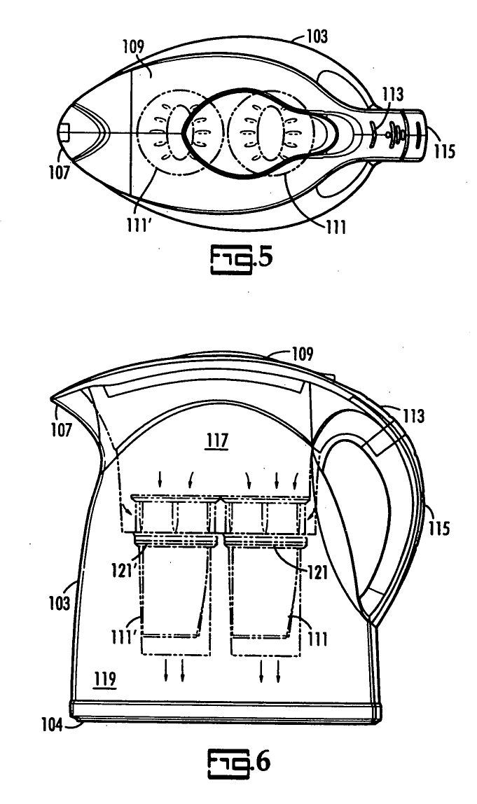

FIG. 5 is a plan view of one embodiment of this invention. The elements correspond to the element shown in FIGS. 1-4. The embodiment is characterized by two filters 111, 111′. Additional filters may be used, depending on volume but the weight of the contents provides a practical limitation for convenient use in a kitchen. It is possible to have carafe systems with multiple filter cartridges as a Counter-top system.

Element 113 is an indicator of the volume of water which passes through the filters based upon the amount added. In this embodiment, it is an event register indicating the number of times that upper chamber 117 has been filled. The invention is not limited specifically by the manner in which the treated volume is determined.

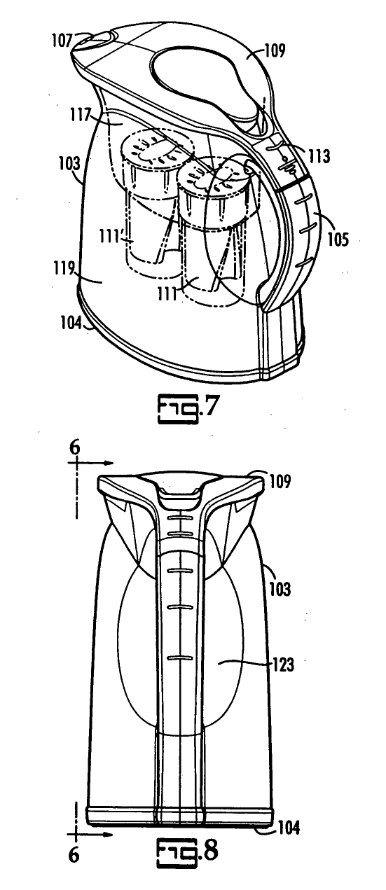

FIGS. 7 and 8 provide perspective views of one embodiment of the invention, including depression 123 which allows the handle to be situated closer to the center of gravity of the pitcher to allow easier manipulation of the filter.

The use of multiple filters provides many benefits not found in older single filter pitchers. Firstly, greater capacity is obtained by greater mass of filter material. Secondly, greater capacity is obtained by the use of finer filter granules which have a greater effective surface area. Thirdly, the filtration rate is not changed, meaning that the user does not have an unacceptable delay in obtaining purified water. Finally, the greater capacity means that the filters are used up less frequently and the time consuming set-up and conditioning procedures normally required for new filters are needed only infrequently.

In a preferred embodiment, the filter medium contains flow facilitators such as pelletized plastic dispersing particles which prevent compaction of the filter media. In a more preferred embodiment, the pelletized plastic dispersant particles contain a bacteriacide or bacteriastat such as 2-phenylphenol, 2,4,4′-trichloro-2′-hydroxydiphenol ether (triclosan), zinc 2-mercaptopyridine-N-oxide, zinc or sodium Omadine®), biguanides such as poly(hexamethylene biguanide) hydrochloride (PHMB), N-alkyl-N,N-dimethyl-N-benzylammonium chloride and silver-zinc zeolites and a combination of two or more of these. In a most preferred embodiment, the pitcher and filter housings that come in contact with water are formed from an antimicrobial plastic.

The compositions of the filter media are not specifically limited and may be adapted to treat any contaminant for which a specific solid treatment medium is available. Heavy metals and VOC's are the preferred targets in most drinking water supplies from a health standpoint, although most people are more concerned about taste and smell.

With the use of this Carafe system we have been able to achieve the following novel results.
1) By using granular activated carbon to remove chlorine, taste and odor, we have been able to double the flow rate of the treated water without any reduction in the removal efficiency. In addition, this has allowed the user to change the filters twice as infrequently as before and allowed treatment of at least twice the volume of water.
2) By using the multiple cartridges, we have been able to add more than one type of media in the filter with affinity for wide range of contaminants than before and thus increase the treatment potential of the carafe system.
3) By using the finer sized granular media, we have been able to improve the kinetics of removal through better contact with the media and allow removal of contaminants that typically require much longer contact times, while still achieving reasonable flow rate. This has resulted in a broad spectrum capability to remove wide range of contaminants for the device
4) By using finer sized granular media without compromising the flow rates, we have been able to increase the percentage removal for the contaminants to a very high degree, at times to undetectable levels.
5) By using multiple cartridges, we are able to improve the EBCT by multiple times resulting in more complete removal of contaminants, frequently to undetectable levels (doubling for two cartridge system) while achieving reasonable gravity flows.
6) By use of flow facilitators—plastic pellets of aspect ratio of 2-4 and specific gravity of 0.9 to 1.2—we have been able to increase the flow rates even further, without compromising on the efficiency of removal.

### INDUSTRIAL UTILITY

The invention finds utility in the removal of toxic metals and organic solvents and pesticides from water used for drinking and cooking. In addition, reduction in undesirable taste and odor makes food and drink more palatable.

The invention has been described in terms of preferred embodiments. Changes and improvements apparent to those with skill in the art are subsumed within the scope of this invention.

1. A water treatment pitcher having an upper chamber for the admission of raw water, a lower chamber for the holding of treated water and a means for treatment of water between said upper chamber and said lower chamber characterized in that the means for treatment comprises multiple filter cartridges.

2. A water treatment pitcher according to claim 1 further comprising an event register to determine the volume of water treated.

3. A water treatment pitcher according to claim 1 wherein the means for treatment of water is a granular media.

4. A water treatment pitcher according to claim 3 wherein the granular media are selected from the group consisting of activated charcoal, aluminia, titania, green sand, iron oxide, zirconia, synthetic ion exchange resins and mixtures thereof.

5. A water treatment pitcher according to claim 1 wherein at least the lower chamber is a plastic treated with an anti-microbial selected from the group consisting of 2-phenylphenol, 2,4,4′-trichloro-2′-hydroxydiphenol ether (triclosan), zinc 2-mercaptopyridine-N-oxide (zinc Omadine®), sodium Omandine®), biguanides such as poly(hexamethylene biguanide) hydrochloride, N-alkyl-N,N-dimethyl-N-benzylammonium chloride and silver-zinc zeolite or a combination of two or more of these.

6. A water treatment pitcher according to claim 1 further comprising flow facilitators to improve flow rate and provide anti-microbial properties to the granular media.
